(19) United States
(12) Patent Application Publication
(10) Pub. No.: US 2015/0004833 A1
(43) Pub. Date: Jan. 1, 2015

(54) COAXIAL CABLE AND CONNECTOR

(71) Applicant: ELECTRONICS AND TELECOMMUNICATIONS RESEARCH INSTITUTE, Daejeon (KR)

(72) Inventors: Seung-Kab RYU, Daejeon (KR); Kyung-Hoon LEE, Daejeon (KR); Kwang-Uk CHU, Daejeon (KR)

(73) Assignee: ELECTRONICS AND TELECOMMUNICATIONS RESEARCH INSTITUTE, Daejeon (KR)

(21) Appl. No.: 14/190,121

(22) Filed: Feb. 26, 2014

(30) Foreign Application Priority Data
Jun. 27, 2013 (KR) 10-2013-0074670

(51) Int. Cl. H01R 9/05

(52) U.S. Cl. CPC H01R 9/0503
USPC 439/578

(57) ABSTRACT

The coaxial cable includes a central conductor, a cable dielectric formed along the outer circumferential surface of the central conductor, and a protruding central conductor configured to protrude from one side of the central conductor and be exposed from the cable dielectric. The diameter of the central conductor is equal to the outer diameter of an end of a transition electrode formed on one side of a connector inner electrode. The connector includes a connector inner electrode configured to be selectively coupled to and separated from a coaxial cable having a central conductor, and provided with a transition electrode on one side thereof, and a connector dielectric formed along the outer circumferential surface of the connector inner electrode. The outer diameter of an end of the transition electrode is equal to the diameter of the central conductor of the coaxial cable.

### CROSS REFERENCE TO RELATED APPLICATION

This application claims the benefit of Korean Patent Application No. 10-2013-0074670, filed on Jun. 27, 2013, which is hereby incorporated by reference in its entirety into this application.

### BACKGROUND OF THE INVENTION

1. Technical Field

The present invention relates generally to a coaxial cable and a connector and, more particularly, to a coaxial cable and a connector that are capable of transmitting impulse signals and continuous sine wave signals having high-voltage, high-power, ultra-wideband characteristics.

2. Description of the Related Art

A high-voltage coaxial cable is formed by surrounding an internal core wire formed of a conductor with an insulation and impedance matching dielectric and then covering the dielectric with an additional conductor, and is used to transmit high-voltage pulse signals without causing dielectric breakdown.

FIGS. 1 and 2 are diagrams illustrating general high-voltage connector heads. As withstand voltage performance increases, a dielectric and a connector inner electrode should be increased in the lengthwise direction thereof. For example, to configure a 100 kV pulse withstand voltage interface, the length of the connector inner electrode and the cable dielectric 3 is increased by a required length (for example, about 33 mm).

To provide a configuration that is compatible with the connector inner electrode and the cable dielectric 3 increased in the lengthwise direction, problems arise in that the length of the inner dielectric of the connector should be increased accordingly, insulation performance is deteriorated by the bending characteristic of the cable due to high-voltage characteristics, and a spatial limitation is imposed on wiring and the location of the connector.

Accordingly, Korean Patent No. 1139943 entitled “High-Voltage Coaxial Cable and Connector” discloses a technology that provides an insulation structure in the direction of a contact surface between connectors, thereby ensuring the flexibility of cable wiring and the disposition of the connectors and preventing connectivity and electrical contact performance from being deteriorated even when a high-voltage coaxial cable core and a connector inner electrode are repeatedly assembled.

The technology disclosed in Korean Patent No. 1139943 is configured as illustrated in FIG. 3. In this technology, a sleeve-shaped dielectric is provided in a plane direction in order to overcome the problem of a high-voltage connector extended in the lengthwise direction thereof, and thus the length of a surface is increased with respect to dielectric breakdown that occurs along the surface of the dielectric, thereby securing insulation performance.

The coaxial cable and the connector illustrated in FIG. 3 can transfer several ten kV or higher and nanosecond or shorter high-voltage pulses to a 50 ohm coaxial cable. The coaxial cable and the connector include a connector inner electrode 110, a coaxial cable single-wire core 120, a coaxial cable dielectric 130, a coaxial cable sheath 140, a washer ring 210, a connector housing 220, a connector auxiliary connection 230, connector fastening parts 240 and 250, and a connector dielectric 310.

In the conventional technology illustrated in FIG. 3, a step is formed at a coupling location where the central conductor of the cable is coupled to the central conductor of the coaxial cable. Accordingly, this conventional technology is problematic in that signal transfer efficiency is deteriorated in GHz or higher high-frequency bands.

FIG. 4 is a diagram illustrating impedance that is determined by the ratio between the inner and outer diameters of the connector illustrated in FIG. 3. In this diagram, impedance that is determined by the ratio between the inner and outer diameters of a coaxial structure is calculated in the lengthwise direction of the cable connector. In particular, impedance is calculated in the range from location “a” where the inner diameter of the connector inner electrode 110 is 11 mm through a coupling surface “b” where coupling to the central conductor of the cable is achieved to location “c” where the inner diameter of the connector inner electrode 110 is 2.7 mm. It can be seen that in the variation range from “a” to “e,” a maximum impedance of 94.5 ohm is achieved at location “c.” That is, in FIG. 4, at location “a,” the inner diameter of the connector inner electrode 110 is 11 mm, and the outer diameter of the connector dielectric 310 is 37 mm. In FIG. 4, at location “b,” the inner diameter of the connector inner electrode 110 is 4 mm, and the outer diameter of the connector dielectric 310 is 26.2 mm. In FIG. 4, at location “c,” the inner diameter of the connector inner electrode 110 is 2.7 mm, and the outer diameter of the connector dielectric 310 is 26.2 mm. In FIG. 4, at location “d,” the inner diameter of the connector inner electrode 110 is 2.7 mm, and the outer diameter of the connector dielectric 310 is 14 mm. In FIG. 4, at location “e,” the inner diameter of the connector inner electrode 110 is 2.7 mm, and the outer diameter of the connector dielectric 310 is 9.4 mm. In the range from location “a” to location “b,” variations in impedance ranging from 50.4 ohm to 78.2 ohm occurred, in the range from location “b” to location “c,” variations in impedance ranging from 78.2 ohm to 94.5 ohm occurred, in the range from location “c” to location “d,” variations in impedance ranging from 94.5 ohm to 68.4 ohm occurred, and in the range from location “d” to location “e,” variations in impedance ranging from 68.4 ohm to 50 ohm occurred.

Meanwhile, with respect to the structure configured to satisfy several ten kV or higher dielectric withstand voltage performance, the length of the dielectric surface is increased in the direction of a connector contact surface, rather than the lengthwise direction, the difference between the diameter of the inner electrode coaxial connector and the core diameter of the coaxial cable occurs. In this case, to secure 50 ohm characteristic impedance in the range from the coaxial cable to the end of the connector, the following Equation should be satisfied in the range of variations in the diameter of the connector inner electrode:

$$Z = \frac{138}{\sqrt{{ɛ}_{r}}} {log}_{10} ( \frac{D}{d} ) \qquad ( 1 )$$

Equation 1 represents the ratio between the inner diameter d of the connector inner electrode 110 and the outer diameter D of the connector dielectric 310 that is used to obtain the line impedance Z of the high-voltage coaxial cable:

$$D = d \cdot {10}^{\frac{Z \sqrt{{ɛ}_{r}}}{138}} \qquad ( 2 )$$

Equation 2 is obtained by converting Equation 1 into the ratio between the inner diameter d of the connector inner electrode 110 and the outer diameter D of the connector dielectric 310. In Equation 2, the outer diameter D of the connector dielectric 310 is obtained by fixing impedance Z to 50, substituting the dielectric constant ε of the connector dielectric 310, and linearly varying the inner diameter d from the diameter of the single wire core 120 of the high-voltage coaxial cable to the inner diameter d of the inner electrode 110 of the connector.

Accordingly, the structure of the linear conversion unit of the connector inner electrode 110 may be determined using the calculated values of the inner diameter d and the outer diameter D.

FIGS. 5A and 5B are diagrams illustrating the coupling of the inner electrode of the connector to the single wire core of the coaxial cable illustrated in FIG. 3. These drawings illustrate the cause of the above-described rapid variations in impedance in detail. Referring to FIGS. 5A and 5B, a threaded hole 105 corresponding to the threads of the single wire core 120 is formed in one side of a connector inner electrode 110, and the single wire core 120 is selectively coupled to and separated from the high-voltage coaxial cable through the engagement between the threads and the threaded hole 205 in a threaded manner.

That is, referring to FIGS. 5A and 5B, the central conductor of the coaxial cable is coupled to the coaxial cable connector via the threads, and thus the diameter of the end of the coaxial cable connector (that is, the connector inner electrode 110) is larger than the outer diameter of the central conductor (that is, the single wire core 120) of the coaxial cable, thereby causing the central conductor to be stepped. Accordingly, the ratio between the inner and outer diameters of the coaxial structure is changed, and thus impedance is changed.

As a result, the conventional technology of FIGS. 3 to 5 has impedance matching performance that is sufficient to transfer several ten kV or higher and several nanosecond or shorter signals and that is insufficient to transfer several ten kV or high and sub-nanosecond or GHz or higher high-voltage high frequency ultra-wideband signals with high efficiency using a 50 ohm system.

### SUMMARY OF THE INVENTION

Accordingly, the present invention has been made keeping in mind the above problems occurring in the conventional art, and an object of the present invention is to provide a coaxial cable and a connector that are capable of satisfying both high-voltage insulation performance and high frequency ultra-wideband impedance matching performance and transmitting GHz or higher high-frequency high-power signals with high efficiency.

In accordance with an aspect of the present invention, there is provided a coaxial cable, including a central conductor; a cable dielectric formed along the outer circumferential surface of the central conductor; and a protruding central conductor configured to protrude from one side of the central conductor and to be exposed from the cable dielectric; wherein the diameter of the central conductor is equal to the outer diameter of an end of a transition electrode formed on one side of a connector inner electrode.

The central conductor and the protruding central conductor may have different diameters.

The outer circumferential surface of the protruding central conductor may be threaded; a threaded hole may be formed through the transition electrode formed on the one side of the connector inner electrode; and the transition electrode may be selectively coupled to and separated from the connector inner electrode in a threaded manner.

The outer surface of the cable dielectric may be stepped.

In accordance with another aspect of the present invention, there is provided a connector, including a connector inner electrode configured to be selectively coupled to and separated from a coaxial cable having a central conductor, and provided with a transition electrode on one side thereof; and a connector dielectric formed along the outer circumferential surface of the connector inner electrode; wherein the outer diameter of an end of the transition electrode is equal to the diameter of the central conductor of the coaxial cable.

A threaded hole may be formed through the transition electrode provided on the one side of the connector inner electrode; and a protruding central conductor may protrude from one side of the central conductor, and the outer circumferential surface of the protruding central conductor is threaded to correspond to the threaded hole; and the connector is selectively coupled to and separated from the coaxial cable in a threaded manner.

The connector dielectric may include a coupling portion configured to be coupled to another connector, and the coupling portion may be formed in a sleeve shape having a predetermined depth.

The diameter of the connector dielectric may linearly increase in response to an increase in the diameter of the connector inner electrode.

The connector inner electrode may be provided with crossed slots or a single slot on the remaining side thereof.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating general high-voltage connector heads;

FIG. 3 is a sectional view of a conventional high-voltage connector;

FIG. 4 is a diagram illustrating impedance that is determined by the ratio between the inner and outer diameters of the connector illustrated in FIG. 3;

FIGS. 5A and 5B are diagrams illustrating the coupling of the inner electrode of the connector to the single wire core of the coaxial cable illustrated in FIG. 3;

FIG. 6 is a diagram illustrating the structure of a coaxial cable and a connector according to an embodiment of the present invention;

FIG. 7 is a diagram illustrating impedance that is determined by the ratio between the inner and outer diameters of the connector illustrated in FIG. 6;

FIG. 8 is a diagram illustrating the cable dielectric and the central conductor of the cable illustrated in FIG. 6 in detail;

FIG. 9 is a diagram illustrating a method of coupling the central conductor of the cable to the central conductor of the connector illustrated in FIG. 6;

FIGS. 10 and 11 are graphs illustrating the broadband impedance matching characteristics of the coaxial cable and the connector according to an embodiment of the present invention; and

FIG. 12 is a graph illustrating the results of the measurement of the coaxial cable and the connector according to the embodiment of the present invention using a network analyzer.

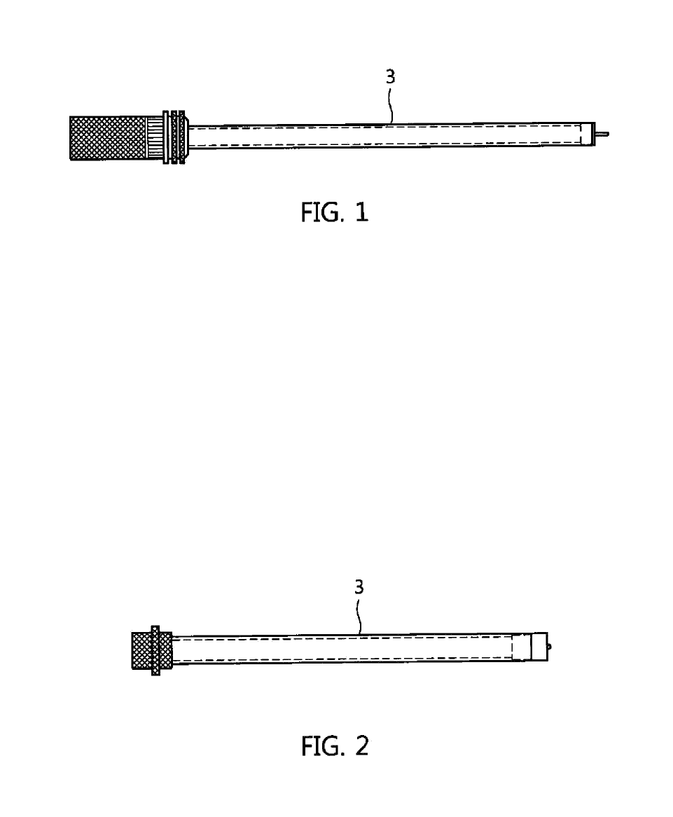

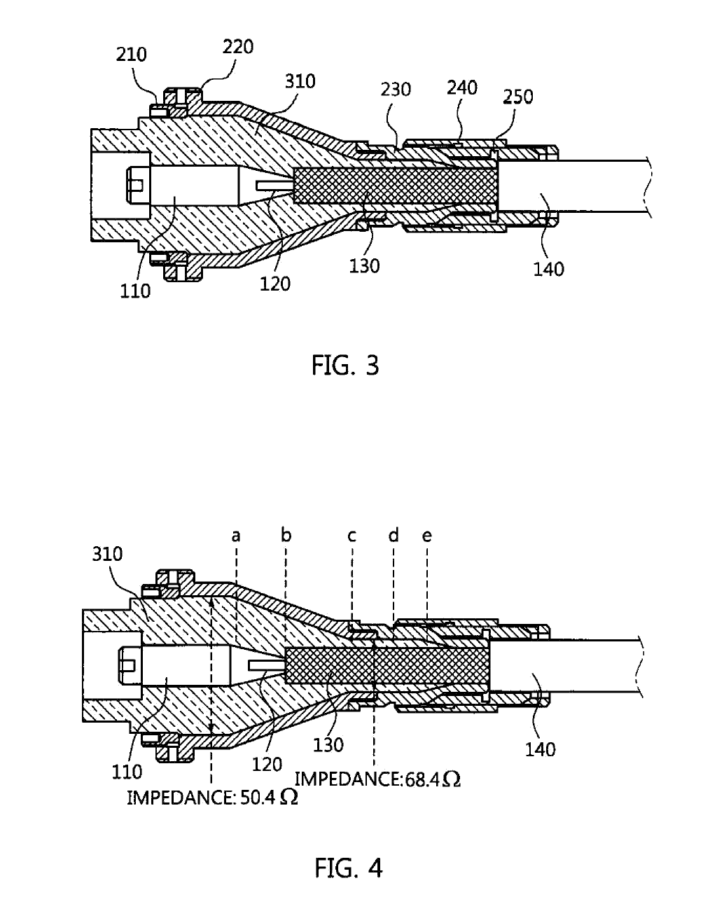

### DESCRIPTION OF THE PREFERRED EMBODIMENTS

A coaxial cable and connector according to the present invention will be described with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

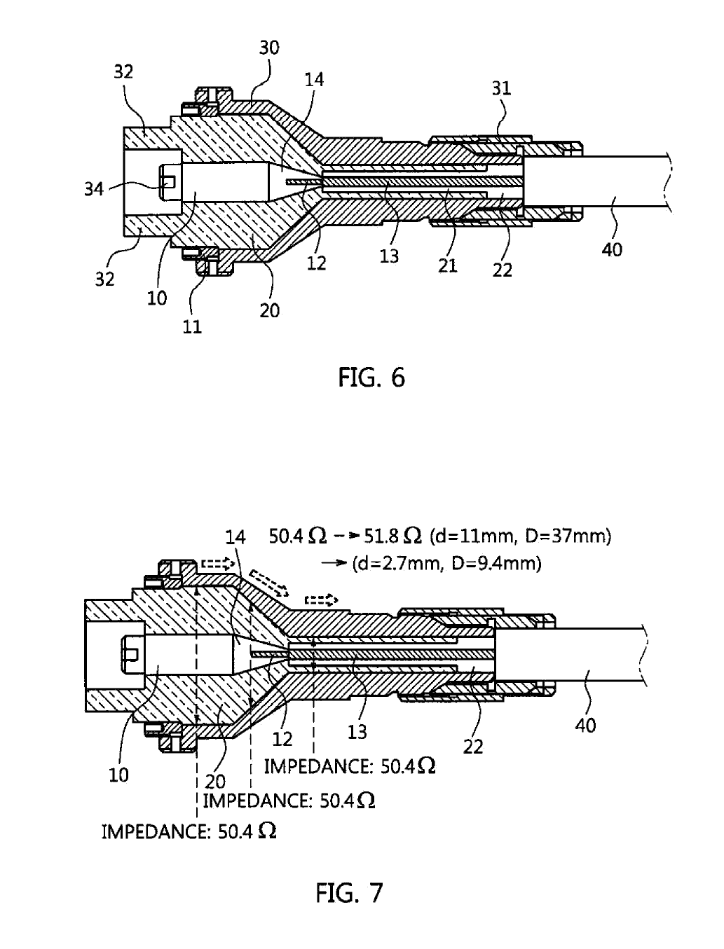

FIG. 6 is a diagram illustrating the structure of a coaxial cable and a connector according to an embodiment of the present invention.

Referring to FIG. 6, the coaxial cable is connected to one side of the connector, and includes a central conductor 13, a protruding central conductor 12, and cable dielectrics 21 and 22.

The central conductor 13 is formed in a circular shape, and may be referred to as a single wire core. In this case, the diameter of the central conductor 13 is equal to the outer diameter of an end of a transition electrode 14 formed on one side of a connector inner electrode 10. This prevents the difference between the outer diameters from occurring upon being coupled to the connector inner electrode 10 of the connector, thereby achieving both high-voltage insulation performance and broadband frequency impedance matching performance that cannot be overcome by the conventional technology. That is, in the conventional technology, when the central conductor of a cable is coupled to the central conductor of a connector (that is, a connector inner electrode), impedance mismatch characteristics occur due to the difference between the diameters of the central conductors. In this embodiment of the present invention, the cable dielectric and the central conductor are stepped, and thus the difference between the outer diameters is prevented from occurring upon being coupled to the central conductor of the connector.

The cable dielectrics 21 and 22 are formed along the outer circumferential surface of the central conductor 13. The cable dielectrics 21 and 22 may be formed of insulators made of plastic resin. The diameter of the cable dielectric 21 is smaller than that of the cable dielectric 22. The entire cable dielectric is machined to be stepped along the lengthwise direction thereof in order to prevent dielectric breakdown and have broadband impedance matching characteristics. Accordingly, the outer surface of the entire cable dielectric is viewed as being stepped. Although the two reference numerals have been assigned to the cable dielectrics, a single reference numeral may be assigned to the entire cable dielectric.

Meanwhile, although not illustrated in FIG. 6, an external conductor, which is a ground metal having a mesh structure, may be formed along the outer circumferential surface of the cable dielectrics 21 and 22. Although a sheath 40 is illustrated as being formed along the outer circumferential surfaces of the cable dielectrics 21 and 22 in FIG. 6, the sheath 40 may be understood as being formed along the outer circumferential surface of the external conductor in a more specific sense.

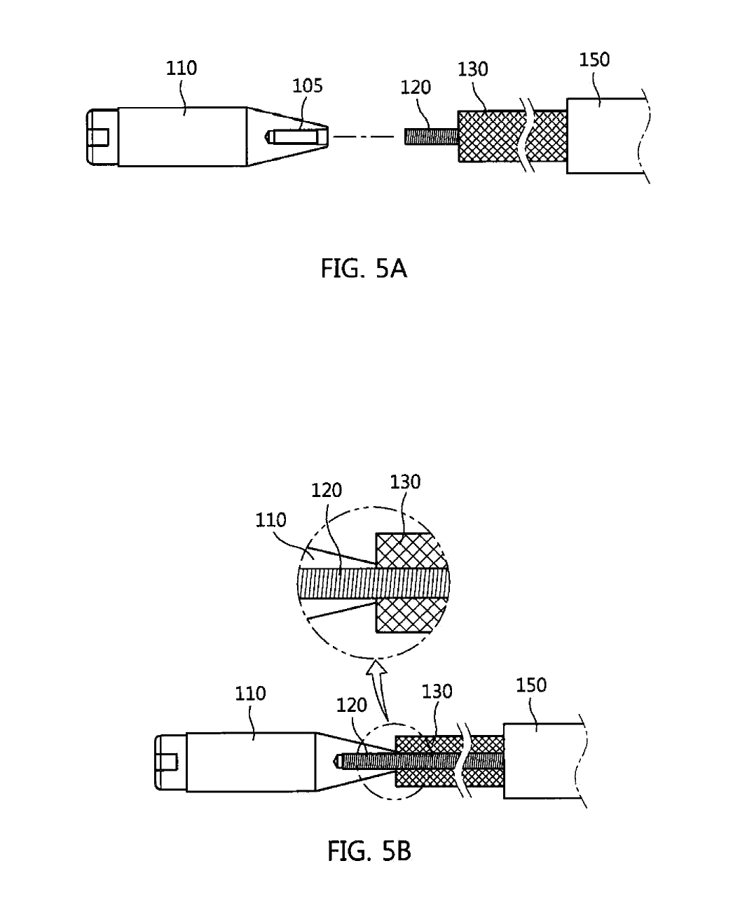

The protruding central conductor 12 protrudes from one side of the central conductor 13 coaxially with the central conductor 13, and is exposed from the cable dielectrics 21 and 22. The protruding central conductor 12 may be made of the same material as the central conductor 13, and may be integrated with the central conductor 13. The central conductor 13 and the protruding central conductor 12 have different diameters. In this case, the protruding central conductor 12 is threaded on the surface thereof. Accordingly, the protruding central conductor 12 is selectively engaged with and separated from the inner electrode of the connector in a threaded manner. Although threads are not illustrated in the drawing, this will be apparent to those skilled in the art from the above-described FIG. 5 and the description thereof.

The above-described central conductor 13 and the protruding central conductor 12 may be denoted by a single reference numeral.

Referring to FIG. 6, the connector includes the connector inner electrode 10, and a connector dielectric 20.

The transition electrode 14 is formed on the one side of the connector inner electrode 10. The connector inner electrode 10 is selectively coupled to and separated from the high-voltage coaxial cable provided with the central conductor 13. The transition electrode 14 is used to be coupled to the central conductor 13 of the cable. In greater detail, a threaded hole is formed through the transition electrode 14. This threaded hole is engaged with the threads that are formed on the outer circumferential surface of the protruding central conductor 12 that protrudes from the central conductor 13. Using this, the connector may be selectively coupled to and separated from the coaxial cable. Although the threaded hole has not been illustrated in the drawing, it will be apparent to those skilled in the art from the above-described FIG. 5 and the description thereof.

Meanwhile, the outer diameter of an end of the transition electrode 14 is equal to the diameter of the central conductor 13 of the coaxial cable. As described above, this prevents the difference between the outer diameters from occurring upon being coupled to the central conductor of the coaxial cable, thereby achieving both high-voltage insulation performance and broadband frequency impedance matching performance that cannot be overcome by the conventional technology.

Two crossed slots or a single slot 34 are formed on the remaining side of the connector inner electrode 10. This is provided to enable the cable and the connector to be engaged with each other by simply rotating the connector inner electrode 10 when the core of the cable, that is, the central conductor 13, is engaged with the connector inner electrode 10 in a threaded manner. When the high-voltage coaxial cable or connector needs to be replaced, the high-voltage coaxial cable or connector may be separated by rotating slot 34 in a counterclockwise direction opposite the direction in which the cable and the connector are engaged with each other. Even if the above process is repeated, permanent replacement or use is possible as long as the threads are not damaged.

The connector dielectric 20 is formed along the outer circumferential surface of the connector inner electrode 10. The connector dielectric 20 is an inductor that is made of plastic resin.

Furthermore, a coupling portion 32 that is used to be coupled to another connector is formed on one side of the connector dielectric 20 in the form of a skirt having a preset depth. The coupling portion 32 is shaped in the form of a protruding sleeve, and may be coupled to another connector. That is, in order to secure tens of kV or higher insulation performance, the surface of the connector dielectric 20 is formed in a sleeve shape and thus extends the length of the surface of the dielectric along a dielectric breakdown path, thereby preventing dielectric breakdown from occurring because of a high-voltage pulse signal. In other words, the length of the surface of the connector dielectric 20 may be viewed as being extended in the direction of the coupling portion 32.

To secure coaxial 50 ohm characteristic impedance, the diameters of the coaxial inner electrode and the dielectric may be linearly increased according to Equation 2. That is, the diameter of the connector dielectric 20 may be linearly increased in response to an increase in the diameter of the connector inner electrode 10.

Meanwhile, the connector dielectric 20 is surrounded by the connector housing 30. The connector housing 30 includes a washer ring 11 and a fastening washer 31 that are used to assemble the connector.

The washer ring 11 is formed in a ring shape, and supports the connector dielectric 20.

The washer 31 surrounds the high-voltage coaxial cable, and fastens the high-voltage coaxial cable and the connector to each other. The washer 31 is formed in a circular metallic tube shape.

Via the above-described configuration illustrated in FIG. 6, several ten kV peak-voltage or GHz or higher high-voltage and high-frequency ultra-wideband signals can be transferred to a cable having 50 ohm or specific impedance. The above-described configuration of FIG. 6 may be viewed as a coaxial cable connector device capable of the high-efficiency transmission of high-voltage ultra-wideband pulses or high-frequency high-power ultra-wideband signals.

FIG. 7 is a diagram illustrating impedance that is determined by the ratio between the inner and outer diameters of the connector illustrated in FIG. 6.

Comparing the embodiment of the present invention with the conventional technology, it can be seen that the conventional technology (see FIG. 4) experienced significant variations in impedance in the section from the location where the inner diameter of the connector inner electrode was 11 mm and the outer diameter of the connector dielectric was 37 mm to the location where the inner diameter of the connector inner electrode was 2.7 mm and the outer diameter of the connector dielectric was 9.4 mm. That is, the conventional technology experienced variations in impedance in the range from 50.4 ohm to 94.5 ohm.

However, the embodiment of the present invention experienced variations in impedance in the range from 50.4 ohm to 51.8 ohm even when the variations in impedance were measured in the section from a location where the inner diameter of the connector inner electrode was 11 mm and the outer diameter of the connector dielectric was 37 mm to a location where the inner diameter of the connector inner electrode was 2.7 mm and the outer diameter of the connector dielectric was 9.4 mm, as in the conventional technology.

As described above, according to the embodiment of the present invention, the range of variations in impedance is narrower than that of the conventional technology, thereby achieving excellent impedance matching performance.

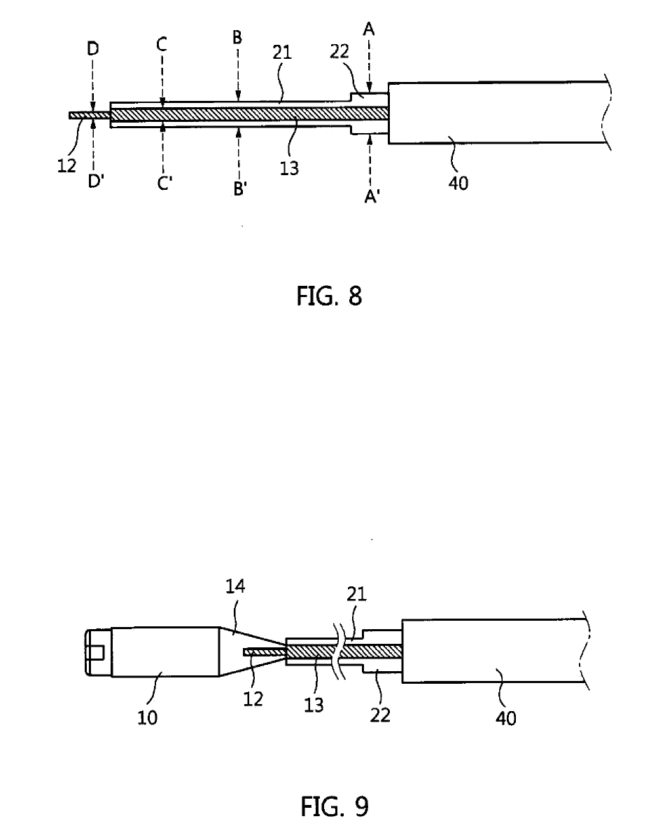

FIG. 8 is a diagram illustrating the cable dielectric and the central conductor of the cable illustrated in FIG. 6 in detail, and FIG. 9 is a diagram illustrating a method of coupling the central conductor of the cable to the central conductor of the connector (that is, the connector inner electrode) illustrated in FIG. 6. FIGS. 8 and 9 may be viewed as diagrams that illustrate structure that are adapted to satisfy voltage, high-frequency and ultra-wideband characteristics at the same time.

To implement the shape of FIG. 8, it is necessary to form a shape that is stepped twice in two stages. In FIG. 8, reference numerals 21 and 22 denote cable dielectrics, and reference numerals 12 and 13 denote the central conductor of a coaxial cable. The cable dielectric is machined such that the diameter thereof is changed from A-A′ to B-B′ in the first stage, and the central conductor of the cable is machined such that the diameter thereof is changed from C-C′ to D-D′ in the second stage. The surface of the central conductor having diameter D-D′ is threaded through dicing.

From FIG. 9, it can be seen that the diameter of the transition electrode 14 of the connector inner electrode 10 is formed to be equal to diameter C-C′ of the central conductor 13 of the cable, and thus there is no variation in the diameter of the central conductor when viewed from the lengthwise direction. That is, it can be seen that coupling is made such that the diameter of the end of the coaxial cable connector is larger than the outer diameter of the central conductor of the coaxial cable in the conventional technology, whereas coupling is made such that the diameter of the end of the connector inner electrode is equal to the outer diameter of the central conductor of the cable in the embodiment of the present invention.

In FIG. 8, the reason why the central conductor of the coaxial cable is machined to be stepped and have diameter D-D′ is to allow a margin of a predetermined length to be provided at an end of the transition electrode 14 in order to be inserted into the connector inner electrode of the connector in the structure of FIG. 9. In FIG. 8, the reason why the cable dielectric is machined to have diameter B-B′ is to prevent a several ten kV or higher high-voltage signal applied to the central conductor from flowing directly to a cable ground and to allow it to be attenuated along the lengthwise direction.

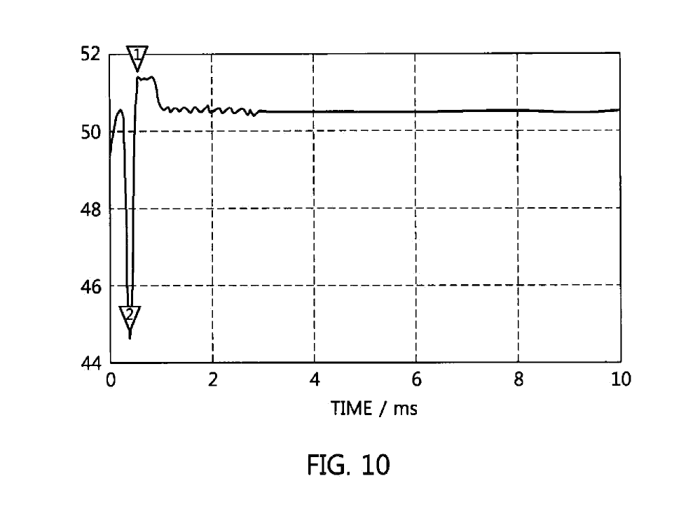

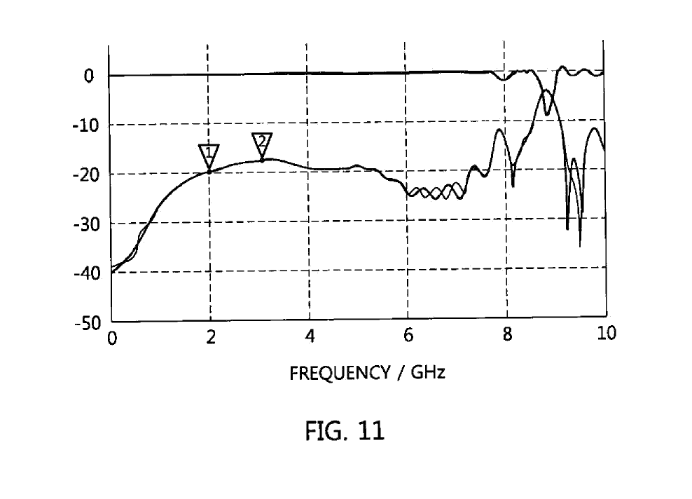

FIGS. 10 and 11 are graphs illustrating the broadband impedance matching characteristics of the coaxial cable and the connector according to an embodiment of the present invention.

FIG. 10 illustrates the results of the analysis of the broadband impedance matching characteristics of the configuration illustrated in FIGS. 6 to 9 using a commercial electromagnetic wave analysis tool (Microwave Studio of CST Corporation). This graph illustrates that a maximum variation in impedance was within 10% of 50 ohm, that is, 45 ohm.

FIG. 11 illustrates the results of the analysis of the broadband impedance matching characteristics of the structure illustrated in FIGS. 6 to 9 using a commercial electromagnetic wave analysis tool (Microwave Studio of CST Corporation). This graph illustrates that the small-signal impedance matching characteristics satisfied values equal to higher than −15 dB in the range equal to or higher than DC to 8 GHz.

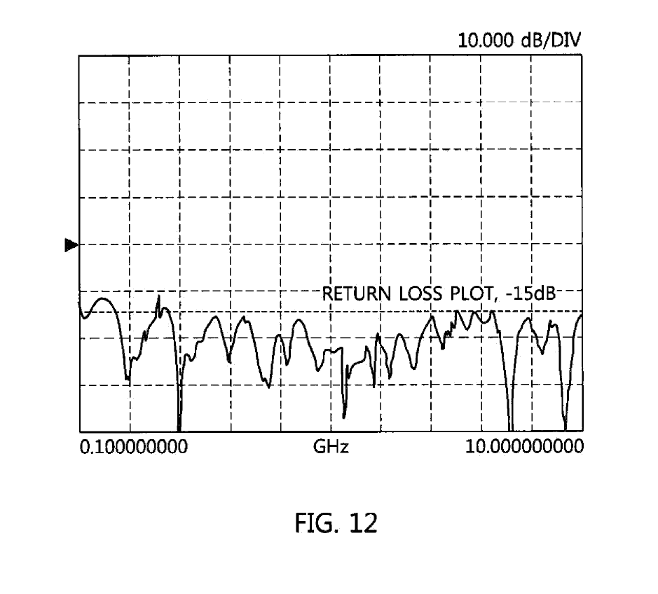

FIG. 12 is a graph illustrating the results of the measurement of the coaxial cable and the connector according to the embodiment of the present invention using a network analyzer.

From FIG. 12, it can be seen that return losses equal to or lower than −15 dB occurred based on 50 ohm in the ultra-wideband frequency band from DC to 10 GHz.

The present invention configured as described above is capable of the cable transmission of an impulse with a several ten kV or higher peak voltage and a sub-nanosecond rise time and the high-efficiency transmission of a GHz or higher high-frequency high-power signal to a system and a cable terminated at 50 ohm, which cannot be achieved by the conventional technology.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A coaxial cable comprising:
a central conductor;
a cable dielectric formed along an outer circumferential surface of the central conductor; and
a protruding central conductor configured to protrude from one side of the central conductor and to be exposed from the cable dielectric;
wherein a diameter of the central conductor is equal to an outer diameter of an end of a transition electrode formed on one side of a connector inner electrode.

2. The coaxial cable of claim 1, wherein the central conductor and the protruding central conductor have different diameters.

3. The coaxial cable of claim 1, wherein:
an outer circumferential surface of the protruding central conductor is threaded;
a threaded hole is formed through the transition electrode formed on the one side of the connector inner electrode; and
the transition electrode is selectively coupled to and separated from the connector inner electrode in a threaded manner.

4. The coaxial cable of claim 1, wherein an outer surface of the cable dielectric is stepped.

5. A connector comprising:
a connector inner electrode configured to be selectively coupled to and separated from a coaxial cable having a central conductor, and provided with a transition electrode on one side thereof; and
a connector dielectric formed along an outer circumferential surface of the connector inner electrode;
wherein an outer diameter of an end of the transition electrode is equal to a diameter of a central conductor of the coaxial cable.

6. The connector of claim 5, wherein:
a threaded hole is formed through the transition electrode provided on the one side of the connector inner electrode;
a protruding central conductor protrudes from one side of the central conductor, and an outer circumferential surface of the protruding central conductor is threaded to correspond to the threaded hole; and
the connector is selectively coupled to and separated from the coaxial cable in a threaded manner.

7. The connector of claim 5, wherein the connector dielectric comprises a coupling portion configured to be coupled to another connector, and the coupling portion is formed in a sleeve shape having a predetermined depth.

8. The connector of claim 5, wherein a diameter of the connector dielectric linearly increases in response to an increase in a diameter of the connector inner electrode.

9. The connector of claim 5, wherein the connector inner electrode is provided with crossed slots or a single slot on a remaining side thereof.
